(19) United States
(12) Patent Application Publication
(10) Pub. No.: US 2010/0079983 A1
(43) Pub. Date: Apr. 1, 2010

(54) LIGHTING DEVICE

(75) Inventor: Tatsumi Kumamoto, Osaka (JP)

Correspondence Address: THE NATH LAW GROUP, 112 South West Street, Alexandria, VA, 22314, US

(73) Assignee: OKUJU CORPORATION, Osaka (JP)

(21) Appl. No.: 12/449,795

(22) PCT Filed: Jul. 16, 2008
(86) PCT No.: PCT/JP2008/062828

§ 371 Date: Aug. 27, 2009

(30) Foreign Application Priority Data
Jul. 19, 2007 (JP) 2007-188056

(51) Int. Cl. F21S 8/00; F21V 1/00

(52) U.S. Cl. 362/147; 362/235

(57) ABSTRACT

Included are a rectangular frame body 10, a box-shaped light reflection enclosure 20 which is disposed to enclose one side of the frame body 10 and which has an inner surface of a light reflection surface 21, a translucent light diffusion film 30 disposed to enclose the other side of the frame body 10, and a linear LED array member 40 having multiple light emitting diodes 42 aligned at predetermined intervals. The LED array member 40 is disposed along at least one edge of the frame body 10. The light emitting diodes 42 emit light to the light reflection surface 21.

### TECHNICAL FIELD

This invention relates to a lighting device, and particularly to a lighting device for surface lighting which has light emitting diodes as light sources.

### BACKGROUND ART

One of existing lighting devices (light boxes) for surface lighting which employs light emitting diodes as light sources includes: an open-front box; at least two wiring boards placed parallel to sidewall portions of the box so as to face to each other; multiple light emitting diodes (LEDs) disposed on each of the wiring boards; a light reflection plate which is disposed at a bottom portion of the box, and has a peak portion protruding toward a front opening portion of the box; and a translucent light diffusion faceplate (light diffusion faceplate made of resin such as acrylic) disposed at the front opening portion of the box (e.g., Patent Document 1). There is also a lighting device which has light-diffusing cloth attached thereto instead of the light diffusion faceplate.

In another lighting device, light emitted by multiple light emitting diodes disposed in an enclosure is diffused by a lens as a first step, and then reflected and diffused with a domical reflection/diffusion member as a second step. After that, the light is focused at a focus point on the central axis of an optical path forming member, and is stored as light energy in the enclosure. Thereafter, the light is led to an opening portion through the space in the optical path forming member and finally is emitted to the outside (e.g., Patent Document 2).

Patent Document 1: JP-A-2006-202729

Patent Document 2: JP-A-2006-19160

### DISCLOSURE OF INVENTION

A light emitting diode is a highly directional light source. Accordingly, in order to perform surface lighting with uniform surface illuminance, a lighting device which employs such light emitting diodes as light sources is required to reflect and diffuse light from the light sources with use of a light reflection plate, a reflection/diffusion member, and the like as in the above-described existing lighting devices.

Existing lighting devices use a light reflection plate having a peak portion or a domical reflection/diffusion member. Accordingly, if a light projection surface is large like an indoor ceiling lighting appliance, the existing lighting device has difficulty in surface lighting with uniform surface illuminance or needs to be large in height to provide surface lighting with uniform surface illuminance. Such an existing device is unsuitable for a ceiling lighting appliance which is installed with embedding in a ceiling of a room.

This invention has been made to solve the above-described problems, and an object of this invention is to provide a lighting device which employs light emitting diodes, which is capable of performing surface lighting with uniform surface illuminance over a wide area without being increased in height, and which is suitable for a ceiling lighting appliance installed with embedding in a ceiling of a room.

A lighting device according to this invention comprises: a frame body having a predetermined shape; a box-shaped light reflection enclosure being disposed to enclose one side of the frame body and having an inner surface of a light reflection surface; a translucent light diffusion film being disposed to enclose another side of the frame body; and a linear LED array member in which a plurality of light emitting diodes are aligned at predetermine intervals. Further, the LED array member is disposed along at least one edge of the frame body, and the light emitting diodes emit light to the light reflection surface of the light reflection enclosure.

In the lighting device according to this invention, preferably, the LED array member is obliquely placed so that light emission axes of the light emitting diodes are directed to the light reflection surface of the light reflection enclosure.

In the lighting device according to this invention, preferably, the frame body is formed in a rectangular shape, the light diffusion film is disposed parallel to a rectangular plane defined by the frame body, and the light reflection surface of the light reflection enclosure has a rectangular flat portion parallel to the rectangular plane and a radius surface portion smoothly connecting each edge of the rectangular flat portion and the corresponding edge of the frame body.

In the lighting device according to this invention, preferably, the LED array member includes a linear wiring board, the light emitting diodes are mounted to the wiring board to be aligned at predetermined intervals, the wiring board is attached to a mounting stage portion disposed in the frame body, and the mounting stage portion is made of aluminum.

Furthermore, in the lighting device according to this invention, the mounting stage portion is preferably integrally formed with a radiating fin.

The lighting device according to this invention is preferably used as a ceiling lighting appliance installed with embedding in a ceiling of a room.

### BRIEF DESCRIPTION OF DRAWINGS

FIG. 1 is a vertical cross-sectional view showing an embodiment of a lighting device according to the present invention.

FIG. 2 is a vertical cross-sectional view schematically showing light beams during lighting of the embodiment of the lighting device according to the present invention.

FIG. 3 is a cross-sectional view taken along line of FIG. 1.

FIG. 4 is an enlarged vertical cross-sectional view showing a principal portion of a different embodiment of the lighting device according to the present invention.

FIG. 5 is an enlarged vertical cross-sectional view showing a principal portion of the different embodiment of the lighting device according to the present invention.

FIG. 6 is an explanatory diagram showing an example of the lighting device according to the present invention.

### BEST MODE FOR CARRYING OUT THE INVENTION

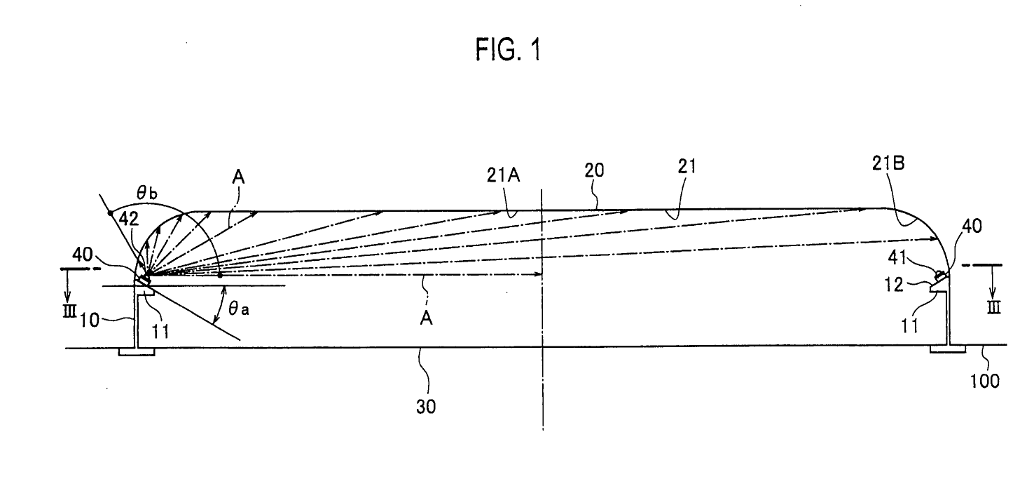

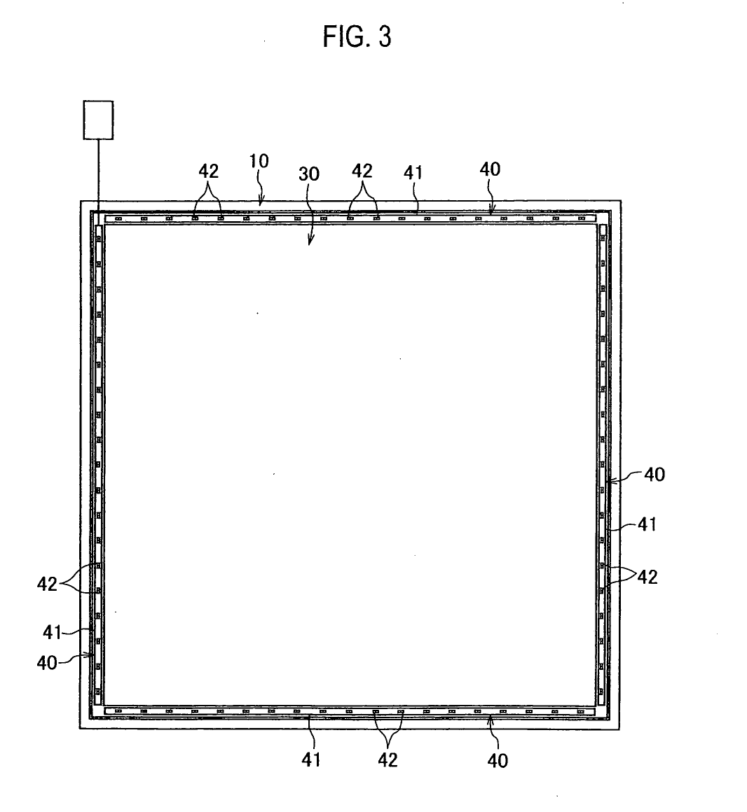

An embodiment of a lighting device according to this invention will be described with reference to FIGS. 1 to 3.

The lighting device of this embodiment includes: a rectangular frame body 10; a box-shaped light reflection enclosure 20 disposed to enclose one side (upper side) of the frame body 10, a translucent light diffusion film 30 disposed to enclose the other side (lower side) of the frame body 10, and narrow linear LED array members (LED light sources) 40 disposed along respective edges (four edges) of the frame body 10. Incidentally, the linear LED array member 40 may be disposed along at least one edge of the frame body 10. In addition, as the shape of the frame body 10, a predetermined shape such as a polygonal or round shape may also be adopted. In the case where the frame body 10 is formed in a round shape or the like, the linear LED array member 40 is formed in a curved shape such as an arc shape in accordance with the shape of the frame body 10.

The LED array member 40 includes a linear wiring board 41 to which multiple light emitting diodes (LEDs) 42 are mounted to be aligned at predetermined intervals.

The light diffusion film 30 is a rough-surfaced film and disposed parallel to the rectangular plane defined by the frame body 20. When the lighting device is installed with embedding in a ceiling of a room, the light diffusion film 30 forms a horizontal surface at the same height as the ceiling 100, thus forming a light projection surface (flat face) flush with the ceiling 100. The rectangular plane defined by the frame body 20 is hereinafter referred to as the horizontal plane in some cases.

The light diffusion film 30 used in this lighting device is made of a translucent incombustible material. As this light diffusion film 30, certified incombustible materials can be used such as glass fiber cloth coated with a white silicone-resin-based coating on both surfaces thereof or glass fiber cloth coated with white fluorine on both surfaces thereof. Incidentally, the light diffusion film 30 may also be made of a combustible material such as acrylic.

The light reflection enclosure 20 is made of an aluminum or aluminum alloy plate, and the entire inner surface thereof functions as a light reflection surface 21. The light reflection surface 21 has a rectangular flat portion 21A and a radius surface portion 21B. The rectangular flat portion 21A is parallel to the rectangular plane (horizontal plane) defined by the frame body 20, i.e., parallel to the light diffusion film 30. The radius surface portion 21B smoothly connects the edges of the rectangular flat portion 21A and those of the frame body 10, respectively. The light reflection surface 21 is in the form of an open-bottomed shallow box. Incidentally, a configuration may also be adopted which includes the light reflection enclosure 20 made of a high-performance white resin film laminated steel plate and the light reflection surface 21 made of a high-performance white resin film. In addition, the light reflection enclosure 20 may also be made of resin rather than metal such as a steel plate.

The frame body 10 is entirely made of aluminum or an aluminum alloy, and integrally formed with an LED-array-mounting stage portion 11 at each edge thereof. Thus, the LED-array-mounting stage portion 11 is made of the same material as the frame body 10, i.e., aluminum or an aluminum alloy.

To an LED-array-mounting surface portion 12, which is formed by the upper surface (facing the light reflection surface 21) of the LED-array-mounting stage portion 11, the wiring board 41 of the LED array member 40 is attached (closely attached). The LED-array-mounting surface portion 12 of the LED-array-mounting stage portion 11 is tilted at a tilt angle θa with respect to the horizontal plane so that the light emission axes of the light emitting diodes 42 of the LED array member 40 is directed to the light reflection surface 21 of the light reflection enclosure 20. Thus, the LED array member 40 is obliquely placed so that the light emission axes of the light emitting diodes 42 is directed to the light reflection surface 21 of the light reflection enclosure 20.

The cone-shaped divergence angle θb made by light emitted by the light emitting diode 42 may be approximately 120°. When the light emitting diodes 42 make such a light emission divergence angle θb, the tilt angle θa may be approximately 10° to 30°.

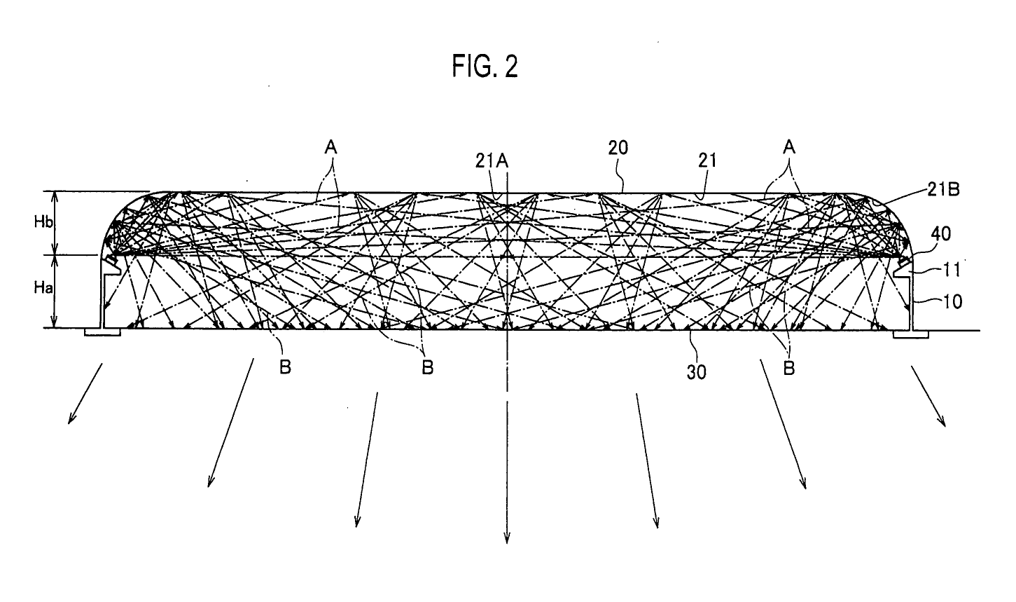

In the lighting device formed as described above, the light emitting diodes 42 of the LED array members 40 at the respective edges are placed obliquely at a tilt angle with respect to the horizontal plane so as to face the light reflection surface 21 of the light reflection enclosure 20. Accordingly, light emitted by the light emitting diodes 42 of the LED array members 40 at the respective edges toward the light reflection surface 21 is directed toward almost the entire light reflection surface 21 as indicated by light beams A in FIGS. 1 and 2. That is, the light emitting diodes 42 emit light to the entire light reflection surface 21 of the light reflection enclosure 20. The light reflected by the light reflection surface 21 then reaches the translucent light diffusion film 30 while being diffused as indicated by light beams B in FIG. 2, and passes through the light diffusion film 30 in a diffused manner. This makes it possible to perform anti-dazzle surface lighting with uniform surface illuminance over a wide area without increasing the height of the device even with the light projection surface, i.e., the light diffusion film 30 having a large area.

During lighting, the light emitting diodes 42 of the LED array members 40 do not generate heat, but in some cases the wiring boards 41 thereof generate heat and thus increase the temperatures thereof. This heat of the wiring boards 41 is transmitted to the LED-array-mounting stage portions 11 made of aluminum or an aluminum alloy, because it is a highly conductive material. Then the heat is radiated from the LED-array-mounting stage portions 11 and the entire frame body 10. Thus, the LED array members 40 are not heated up to high temperatures even after long periods of continuous lighting.

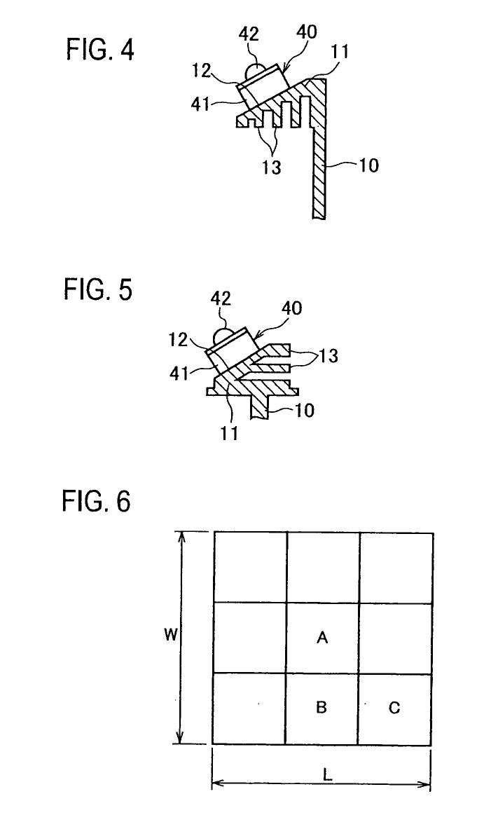

The heat radiation efficiency from these LED-array-mounting stage portions 11 can be improved by forming radiating fins 13 in the LED-array-mounting stage portions 11 as shown in FIGS. 4 and 5.

Next, examples of the lighting device according to this invention and illuminance test results thereof will be described.

As shown in FIG. 6, both of the dimensions L and W of the light projection surface formed by the light diffusion film 30 were set as L=542 mm and W=542 mm for all of examples 1 to 6. The light projection surface was divided into nine equal zones. For each of three zones A, B, and C out of the nine equal zones, illuminance was measured with a digital illuminometer (LM-8000, manufactured by Fuso Rikaseihin Co., Ltd.). The number of the light emitting diodes 42 of the LED array member 40 at each edge (four edges) was 32. The light emitting diodes 42 were white ones with a light emission divergence angle θb of 120°.

### Example 1

The vertical distance Ha between the mounting position of each LED array member 40 and the rectangular flat portion 21A of the light reflection surface 21 was set to 20 mm. The vertical distance Hb and tilt angle θa between the mounting position of each LED array member 40 and the light diffusion film 30 were set to 80 mm and 30°, respectively. An illuminance test result of example 1 is shown in Table 1.

### Example 2

The vertical distance Ha between the mounting position of each LED array member 40 and the rectangular flat portion 21A of the light reflection surface 21 was set to 20 mm. The vertical distance Hb and tilt angle θa between the mounting position of each LED array member 40 and the light diffusion film 30 were 80 mm and 10°, respectively. An illuminance test result of example 2 is shown in Table 2.

### Example 3

The vertical distance Ha between the mounting position of each LED array member 40 and the rectangular flat portion 21A of the light reflection surface 21 was set to 20 mm. The vertical distance Hb and tilt angle θa between the mounting position of each LED array member 40 and the light diffusion film 30 were set to 130 mm and 30°, respectively. An illuminance test result of example 3 is shown in Table 3.

### Example 4

The vertical distance Ha between the mounting position of each LED array member 40 and the rectangular flat portion 21A of the light reflection surface 21 was set to 20 mm. The vertical distance Hb and tilt angle θa between the mounting position of each LED array member 40 and the light diffusion film 30 were set to 130 mm and 10°, respectively. An illuminance test result of example 4 is shown in Table 4.

### Example 5

The vertical distance Ha between the mounting position of each LED array member 40 and the rectangular flat portion 21A of the light reflection surface 21 was set to 65 mm. The vertical distance Hb and tilt angle θa between the mounting position of each LED array member 40 and the light diffusion film 30 were set to 130 mm and 30°, respectively. An illuminance test result of example 5 is shown in Table 5.

### Example 6

The vertical distance Ha between the mounting position of each LED array member 40 and the rectangular flat portion 21A of the light reflection surface 21 was set to 65 mm. The vertical distance Hb and tilt angle θa between the mounting position of each LED array member 40 and the light diffusion film 30 were 130 mm and 10°, respectively. An illuminance test result of example 6 is shown in Table 6.

TABLE 1
Illuminance (1x)

| Distance from | Measurement Position | | |
|---|---|---|---|
| Light Projection Surface | A: | B: | C: |
| 0 mm | 1500 | 2320 | 1550 |
| 750 mm | 361 | 144 | 95 |
| 1100 mm | 181 | 133 | 72 |
| 1450 mm | 106 | 78 | 50 |
| 1670 mm | 70 | 62 | 41 |
| 2140 mm | 48 | 42 | 27 |

TABLE 2
Illuminance (1x)

| Distance from | Measurement Position | | |
|---|---|---|---|
| Light Projection Surface | A: | B: | C: |
| 0 mm | 1900 | 2990 | 2770 |
| 750 mm | 352 | 139 | 122 |
| 1100 mm | 176 | 111 | 97 |
| 1450 mm | 104 | 77 | 69 |
| 1670 mm | 76 | 61 | 56 |
| 2140 mm | 48 | 42 | 37 |

TABLE 3
Illuminance (1x)

| Distance from | Measurement Position | | |
|---|---|---|---|
| Light Projection Surface | A: | B: | C: |
| 0 mm | 1630 | 1700 | 1650 |
| 750 mm | 248 | 94 | 85 |
| 1100 mm | 126 | 75 | 68 |
| 1450 mm | 74 | 54 | 48 |
| 1670 mm | 55 | 44 | 40 |
| 2140 mm | 35 | 29 | 26 |

TABLE 4
Illuminance (1x)

| Distance from | Measurement Position | | |
|---|---|---|---|
| Light Projection Surface | A: | B: | C: |
| 0 mm | 1370 | 1730 | 1470 |
| 750 mm | 227 | 88 | 76 |
| 1100 mm | 113 | 69 | 63 |
| 1450 mm | 67 | 48 | 43 |
| 1670 mm | 50 | 39 | 35 |
| 2140 mm | 30 | 27 | 24 |

TABLE 5
Illuminance (1x)

| Distance from | Measurement Position | | |
|---|---|---|---|
| Light Projection Surface | A: | B: | C: |
| 0 mm | 1650 | 1700 | 1500 |
| 750 mm | 245 | 95 | 93 |
| 1100 mm | 125 | 74 | 72 |
| 1450 mm | 73 | 62 | 50 |
| 1670 mm | 54 | 42 | 39 |
| 2140 mm | 34 | 28 | 27 |

TABLE 6
Illuminance (1x)

| Distance from | Measurement Position | | |
|---|---|---|---|
| Light Projection Surface | A: | B: | C: |
| 0 mm | 1550 | 1730 | 1500 |
| 750 mm | 242 | 90 | 93 |
| 1100 mm | 122 | 73 | 71 |
| 1450 mm | 72 | 52 | 49 |
| 1670 mm | 52 | 40 | 37 |
| 2140 mm | 33 | 28 | 26 |

In all of examples 1 to 6, a favorable surface lighting state with little illuminance unevenness was obtained at a distance of 1670 mm, which is equivalent to the height of the top of an office desk.

Other advantages of the lighting device of this embodiment will be listed below.

(1) LED light sources emit light without heat and consume less power than fluorescent tubes and light bulbs. Accordingly, the amount of heat discharge and power consumption during lighting can be reduced.
(2) LED light sources last longer than fluorescent tubes and light bulbs. Thus, the costs of replacing, maintaining, and discarding lamps or the like can be reduced. Also, pressure on the environment can be reduced.
(3) A huge increase in size of office buildings raises concerns about the fall of lighting appliances during earthquakes. Although fall prevention measures have been taken in current devices as a matter of course, the decreased weight of the device (30% or more of the weights of known devices in the same form) enhances fall prevention measures.
(4) Glass fiber cloth certified as being incombustible is used as a surface finish in the light diffusion film. Accordingly, the device can be installed without violating building interior restrictions.

As described above, in the lighting device, the linear LED array member is disposed along at least one edge of the rectangular frame body, the light emitting diodes aligned at predetermined intervals emit light to the light reflection surface of the light reflection enclosure, and the light reflected by the light reflection surface reaches the translucent light diffusion film in a diffused state, and passes through the light diffusion film in a diffused manner. This enables the lighting device, even with the light projection surface having a large area, to perform surface lighting with uniform surface illuminance over a wide area, without a height increase of the device.

1. A lighting device comprising:
a frame body having a predetermined shape;
a box-shaped light reflection enclosure being disposed to enclose one side of the frame body and having an inner surface of a light reflection surface;
a translucent light diffusion film being disposed to enclose another side of the frame body; and
a linear LED array member in which a plurality of light emitting diodes are aligned at predetermine intervals,
wherein the LED array member is disposed along at least one edge of the frame body, and
the light emitting diodes emit light to the light reflection surface of the light reflection enclosure.

2. The lighting device according to claim 1, wherein the LED array member is obliquely placed so that light emission axes of the light emitting diodes are directed to the light reflection surface of the light reflection enclosure.

3. The lighting device according to claim 1, wherein
the frame body is formed in a rectangular shape,
the light diffusion film is disposed parallel to a rectangular plane defined by the frame body, and
the light reflection surface of the light reflection enclosure has a rectangular flat portion parallel to the rectangular plane and a radius surface portion smoothly connecting each edge of the rectangular flat portion and the corresponding edge of the frame body.

4. The lighting device according to claim 1, wherein
the LED array member includes a linear wiring board,
the light emitting diodes are mounted to the wiring board to be aligned at predetermined intervals,
the wiring board is attached to a mounting stage portion disposed in the frame body, and
the mounting stage portion is made of aluminum.

5. The lighting device according to claim 4, wherein the mounting stage portion is integrally formed with a radiating fin.

6. The lighting device according to claim 1, is a ceiling lighting appliance installed with embedding in a ceiling of a room.

7. The lighting device according to claim 2, wherein
the frame body is formed in a rectangular shape,
the light diffusion film is disposed parallel to a rectangular plane defined by the frame body, and
the light reflection surface of the light reflection enclosure has a rectangular flat portion parallel to the rectangular plane and a radius surface portion smoothly connecting each edge of the rectangular flat portion and the corresponding edge of the frame body.
